(19) United States
(12) Patent Application Publication
(10) Pub. No.: US 2012/0187195 A1
(43) Pub. Date: Jul. 26, 2012

(54) SYSTEMS AND METHODS FOR READING ENCODED DATA THROUGH GAPS BETWEEN CONVEYORS IN AN AUTOMATED CHECKOUT SYSTEM

(75) Inventors: Robert J. Actis, Eugene, OR (US); Michael Ahten, Eugene, OR (US); Michael P. Svetal, Eugene, OR (US)

(73) Assignee: Datalogic ADC, Inc., Eugene, OR (US)

(21) Appl. No.: 13/356,417

(22) Filed: Jan. 23, 2012

Related U.S. Application Data
(60) Provisional application No. 61/435,744, filed on Jan. 24, 2011.

(51) Int. Cl. G06K 13/04

(52) U.S. Cl. 235/479

(57) ABSTRACT

An automated checkout system and method of operation for reading encoded data, such as barcode labels, on a bottom surface of an item using a data reader. The automated checkout system includes a leading and a trailing conveyor separated by a gap, where the leading conveyor may be vertically offset in relation to the trailing conveyor such that the item tilts or drops slightly as it moves between the conveyors. A data reader is positioned beneath the conveyors to read the encoded data through the gap as the item transitions from the leading conveyor onto the trailing conveyor. The automated checkout system may include a transition element, such as a transfer plate or guide rollers, to bridge the gap between the conveyors to provide a smooth transfer between the conveyors, prevent items from becoming lodged between the conveyors, and prevent debris from falling through and collecting on the data reader.

### RELATED APPLICATION DATA

This application claims priority to U.S. Provisional Patent Application No. 61/435,744, filed Jan. 24, 2011, which is hereby incorporated by reference.

### BACKGROUND

The field of this disclosure relates generally to automated checkout systems and methods of operation, and more particularly, to automated checkout systems incorporating a data reader below an item's path of travel to capture encoded data located on a bottom surface of the item.

Scanners and other data reading devices are used to read optical codes, acquire data, and capture a variety of images. One common data reader device is an optical code reader. Optical codes typically comprise a pattern of dark elements and light spaces. There are various types of optical codes, including linear or one-dimensional codes such as a Universal Product Code (“UPC”) and EAN/JAN barcodes.

Barcode scanners are well known for scanning UPC and other types of barcodes on packages, particularly in retail stores. Generally, barcode scanners are installed at checkout stands or are built into a horizontal checkout counter so that a scan pattern is projected through a transparent window to read the barcode on the package. Normally, a customer places packages on a counter, a deck, or a conveyor. In a semi-automatic system, a checkout clerk then takes each package and moves the package through the scanner's scanning area to capture the encoded data on the barcode label.

One disadvantage of this technique is that the checkout clerk (or the customer in a self-checkout system) may need to first locate the optical code on the package (e.g., a barcode label) and then hold or move the package with a particular orientation to obtain an accurate reading by the scanner as the barcode moves through the scanning area. Misalignment of the barcode lines or inadvertent movement of the package during the scanning operation can result in a misreading or a non-reading of the barcode. In retail self-checkout systems, these problems may be exacerbated by inexperience of the user (the user being a customer) and the difficulty in finding the barcode label for some packages.

One possible solution to the problem of locating the barcode labels is an automated checkout system with a data capturing system that can effectively scan all of the exterior surfaces of the package to find the barcode label. The data capturing system may include one or more discrete subsystems (e.g., optical data readers, such as imaging readers and flying spot laser scanners, and RFID readers) arranged to scan and read data located on the outward-facing surfaces of the item or on RFID tags either on or inside the product packaging. Automated checkout systems may include a moving conveyor and a data capturing system, where the moving conveyor transports an item having a barcode through the data capturing system, which scans the surfaces of the item and captures the barcode. The moving conveyor thereafter transports the item to a downstream area, which in the case of a retail checkout application may constitute a bagging area where the scanned/purchased items can be gathered and bagged.

However, although an automated checkout system may help solve some issues with locating the barcode label on items, the present inventors have recognized certain limitations with such automated checkout systems. Current automated checkout systems either cannot read or have difficultly accurately capturing optical codes located on a conveyor-contacting, bottom surface of the item because the barcode label is blocked from view. Consequently, a checkout clerk or customer has to remove the item from the conveyor and reposition it so that the barcode is not on the bottom surface. In some cases, manual processing of items may be necessary, thereby drastically reducing or even eliminating the convenience of an automated checkout system. Additionally, this difficulty reading the bottom surface of an item may require constant repositioning and reprocessing of items, leading to long customer wait times and increased customer frustration. Moreover, the need for constant supervision and excessive manual manipulation of items defeats the fundamental purpose of an automated checkout system.

### SUMMARY

Methods and apparatus relating to an automated checkout system are disclosed for improved reading and processing of items bearing encoded data, such as barcode labels, on a bottom surface of an item.

For example, one embodiment includes a leading conveyor and a trailing conveyor separated by a gap, where the leading conveyor is raised in relation to the trailing conveyor. A data reader is positioned beneath the leading and trailing conveyors and oriented to capture encoded data located on a bottom surface of an item by reading to encoded data through the gap as the item crosses between the conveyors.

In another embodiment, the automated checkout system may further include an air blower positioned beneath the conveyors and oriented to direct air flow over the data reader to keep dirt, lint, dust, or other debris from collecting on the surface of the data reader. Alternatively or in addition, a second air blower may be provided and oriented to direct air flow through the gap between the leading and trailing conveyors to help prevent debris from falling through onto the data reader.

In yet another embodiment, the automated checkout system may include a transfer plate positioned across at least part of the gap to help items transition smoothly from the leading conveyor onto the trailing conveyor. The transfer plate may be comprised of a transparent material such that the transfer plate does not substantially interfere with the performance of the data reader in reading the barcode label as the item crosses the transfer plate.

In still another embodiment, the automated checkout system may include a plurality of guide rollers spaced apart across the gap between the conveyors. The guide rollers may be positioned to help items transition between the conveyors, while also providing a sufficiently large gap through which the data reader can read the barcode labels of passing items. Though the guide rollers may be opaque, they may comprise a transparent material such that the guide rollers do not interfere with the performance of the data reader in reading the barcode label on passing items.

Additional aspects and advantages will be apparent from the following detailed description of preferred embodiments, which proceeds with reference to the accompanying drawings. The drawings depict only certain preferred embodiments and are not to be considered as limiting in nature.

### BRIEF DESCRIPTION OF THE DRAWINGS

FIG. 1 is an isometric view of an automated checkout system, according to a first embodiment, with leading and trailing conveyor sections and an exemplary six-sided, box-shaped item located on the leading conveyor section and being moved toward a tunnel or portal scanner data capture device.

FIG. 2 is a simplified illustration of the automated checkout system of FIG. 1 showing a data reader positioned beneath the conveyors on an interior portion of a housing structure for the automated checkout system, with the upper portion of the tunnel scanner removed.

FIG. 3 is a schematic diagram of an alternative system with the leading conveyor section in a raised position in relation to the trailing conveyor and showing the data reader scanning through the gap.

FIG. 4 is a schematic diagram of another alternative system with a transfer plate positioned across the gap for helping the item smoothly transition between the conveyors.

FIG. 5 is a schematic diagram of another alternative system with a pair of transfer plates positioned across the gap separated by a space to allow the data reader to scan the item through the space.

FIGS. 6 and 7 are schematic diagrams of another alternative system with guide rollers positioned across the gap and the data reader scanning the item through the gap between the guide rollers.

FIG. 8 is a schematic diagram of another alternative system with a pair of air blowers positioned below the conveyors, with one air blower directing air flow over the data reader and the other directing air flow through the gap to help prevent debris from falling through and accumulating on the data reader.

### DETAILED DESCRIPTION OF PREFERRED EMBODIMENTS

With reference to the drawings, this section describes particular embodiments and their detailed construction and operation. The embodiments described herein are set forth by way of illustration only and not limitation. The described features, structures, characteristics, and methods of operation may be combined in any suitable manner in one or more embodiments. In view of the disclosure herein, those skilled in the art will recognize that the various embodiments can be practiced without one or more of the specific details or with other methods, components, materials, or the like. In other instances, well-known structures, materials, or methods of operation are not shown or not described in detail to avoid obscuring more pertinent aspects of the embodiments.

In the following description of the figures and any example embodiments, it should be understood that an automated checkout system in a retail establishment is merely one use for such a system and should not be considered as limiting. Other uses for an automated checkout system with the characteristics and features described herein may be possible, for example, in an industrial location such as a parcel distribution (e.g., postal) station.

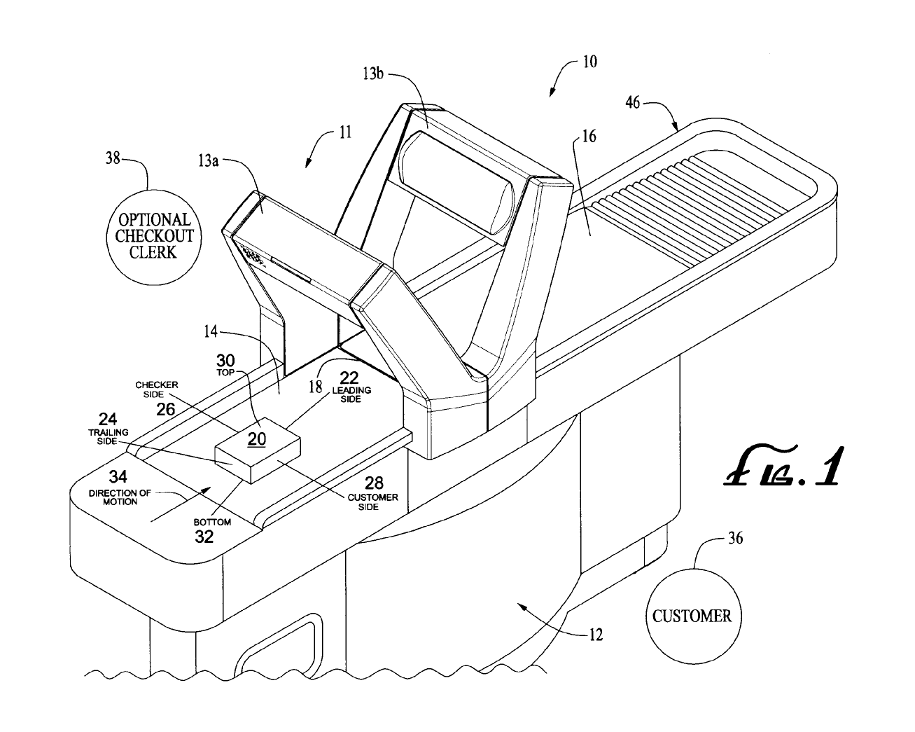

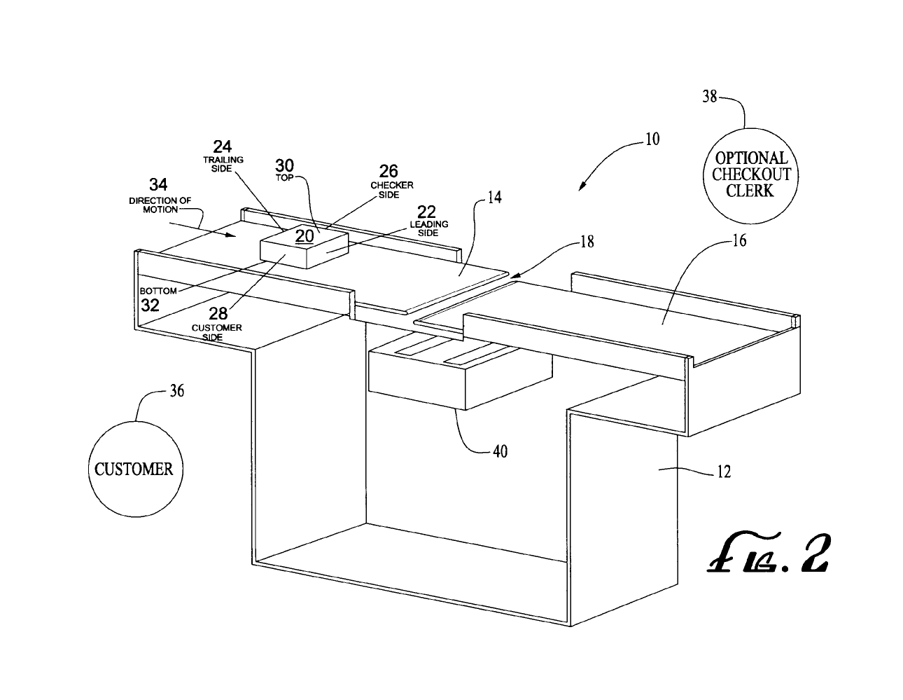

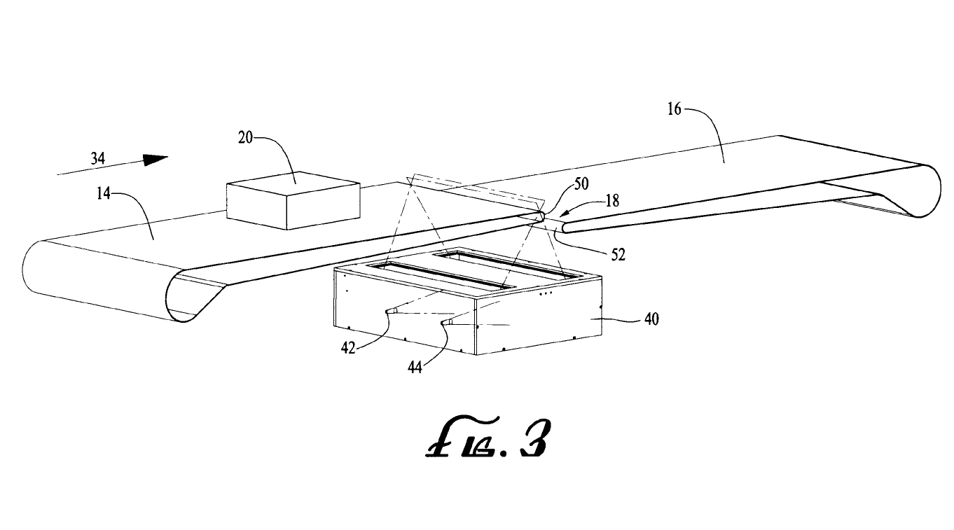

FIGS. 1-3 illustrate an automated checkout system 10 according to a first embodiment. In one example operation, the automated checkout system 10 may be used to read and process a barcode label on a bottom surface 32 of an item 20 during a checkout process, such as in a retail establishment or supermarket. In an example operation, a customer 36 or clerk 38 (hereinafter, collectively referred to as a “user”) places the item 20 onto a leading conveyor 14 and the leading conveyor 14 transports the item 20 in a substantially linear direction of motion 34 toward a trailing conveyor 16. The leading conveyor 14 and the trailing conveyor 16 are spaced apart by a gap 18, with the leading conveyor 14 being slightly raised (i.e., the leading conveyor terminating at a slightly raised elevation proximate and relative to the trailing conveyor) in relation to the trailing conveyor 16 such that when the item 20 transitions between the leading conveyor 14 to the trailing conveyor 16, the item 20 crosses the gap 18 and tilts or drops slightly onto the trailing conveyor 16. As the item 20 moves across the gap 18, the barcode label on the bottom surface 32 of the item 20 is exposed to a data reader 40 positioned below the conveyors 14, 16 and oriented to have a field of view projecting through the gap 18. The data reader 40 captures the entire barcode label as the item 20 completes its transition across the gap 18. The item 20 may then be transported on the trailing conveyor 16 to a bagging area 46 where the user or other person can bag the item 20. Further details of an example tunnel scanner, including a bottom scanner, are disclosed in U.S. Application No. 61/435,777, filed Jan. 24, 2011, hereby incorporated by reference.

FIGS. 1-3 collectively illustrate an example embodiment of an automated checkout system 10 for reading a barcode label on a bottom surface 32 of an item 20. With reference to FIGS. 1-3, in a preferred embodiment, the automated checkout system 10 includes a housing structure 12 suitable for containing various components of the automated checkout system 10. The automated checkout system 10 may include a data capture device 11 having a first arch 13a and a second arch 13b coupled to the housing structure 12. The first and second arches 13a, 13b may include one or more data readers positioned therein for capturing various views and reading barcode labels on the item 20.

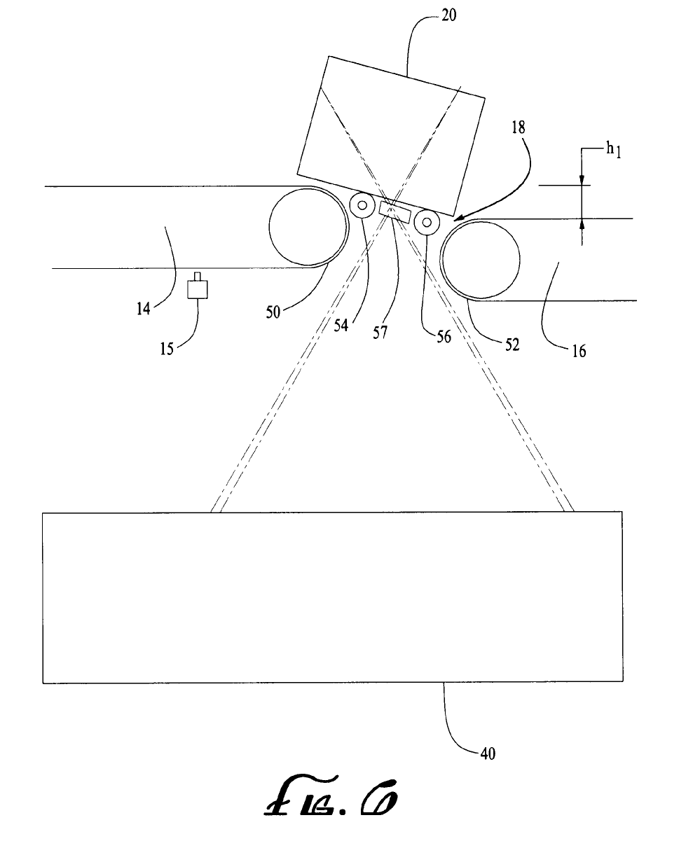

In the automated checkout system 10, the leading conveyor 14 and the trailing conveyor 16 may be separated by a gap 18 of approximately four millimeters. The gap 18 extends along a length corresponding to the width of the conveyors 14, 16. Additionally, the leading conveyor 14 is raised by approximately 1.25 millimeters (see h₁ in FIG. 6) in relation to the trailing conveyor 16, creating a step down between the leading conveyor 14 and the trailing conveyor 16 angled between approximately fifteen and twenty degrees, preferably approximately seventeen degrees.

In some embodiments, the gap 18 may be positioned between the first arch 13a and the second arch 13b, such as in a substantially central location of the data capture device 11. In other embodiments, the gap 18 may be positioned upstream in relation to the first arch 13a (i.e., a position where the item 20 first crosses the gap 18 and thereafter passes between the data capture device 11) or downstream in relation to the second arch 13b (i.e., a position where the item 20 first passes between the data capture device 11 and thereafter crosses the gap 18). Further details and advantages of such embodiments are disclosed in U.S. Application No. 61/505,935, filed Jul. 8, 2011, hereby incorporated by reference.

Although the embodiment in FIG. 1 illustrates an open space between the first and second arches 13a, 13b, the first and second arches 13a, 13b may be embodied in an elongated tunnel formed over or around the conveyors 14, 16. The automated checkout system 10 may thus be partially open and partially enclosed, such as the example illustrated in FIG. 1, or fully enclosed such as via a tunnel enclosure. The configuration of the first and second arches 13a, 13b creates an open architecture that provides some barrier/inhibition from a customer reaching into the read zone, while also providing sight lines for allowing the customer to generally continuously observe items passing through the arches 13a, 13b. A tunnel scanner need not include any fully enclosed tunnel structure or even semi-enclosed arches, but a suitable tunnel scanner may be constructed with more or less openness between the arches 13a, 13b.

In a preferred embodiment, the conveyors 14, 16 are oriented and configured to transport the item 20, represented as a six-sided, box-shaped package having a leading side 22, a trailing side 24, a checker side 26, a customer side 28, a top surface 30, and a bottom surface 32, through the automated checkout system 10 in a substantially linear direction of motion 34. The description regarding the checker side 26 and the customer side 28 is meant to establish a frame of reference related to the position of the customer 36 and the checkout clerk 38 as illustrated in FIG. 1, to facilitate description, and is not intended to be limiting. It should be understood that the automated checkout system 10 may be used without a checkout clerk 38, and the customer 36 may be positioned at either side of the automated checkout system 10. For convenience, item 20 is described as a box-shaped package, but it should be understood that item 20 may encompass other shapes, including irregularly shaped packages, such as a bag of oranges, potato chips, or the like. Additionally, although item 20 may contain a barcode label on any one or more of the six sides 22, 24, 26, 28, 30, and 32 described herein, for purposes of discussion, the barcode label will be described with reference to its affixation on a conveyor-contacting bottom surface 32 of the item 20.

In other embodiments, the size of the gap 18 may be smaller or larger than four millimeters and the angle of inclination between the conveyors 14, 16 may be smaller or larger than 17 degrees depending on the intended use and other variables related to the automated checkout system 10. For instance, a retail establishment that processes items of various sizes may want to keep the gap 18 fairly small (e.g., on the order of less than 10 millimeters) to accommodate the many thinner items, such as gift cards or greeting cards, and prevent those items from becoming lodged in or falling through the gap 18. A warehouse, on the other hand, dealing primarily with larger packages can have a larger gap 18 (e.g., on the order of a few inches or more) without concern that the packages will fall through or become lodged.

Preferably, the conveyors 14, 16 are positioned along a substantially longitudinal axis and oriented such that item 20 travels in a substantially linear direction of motion 34 along the automated checkout system 10. In addition, the conveyor 14 is disposed along a first plane that is at an elevated position (i.e., vertically offset) in relation to a second plane on which the conveyor 16 is disposed. For instance, the first plane may be spaced apart from the second plane by a vertical offset of between one and two millimeters such that the first plane is positioned slightly above the second plane.

In another embodiment, the conveyors 14, 16 may have a different directional orientation, such as a semi-circular configuration wrapping around the customer 36 or checkout clerk 38. In such a configuration, the conveyors 14, 16 may each have a curved portion and a straightened portion, where the straightened portion of the leading conveyor 14 is substantially aligned with the straightened portion of the trailing conveyor 16 and the respective straightened portions of the conveyors 14, 16 are separated by the gap 18. The operation regarding the processing and reading of the item 20 may be substantially the same as described with respect to the preferred embodiment where the conveyors 14, 16 are disposed along a substantially longitudinal axis.

The automated checkout system 10 further includes a data reader 40 preferably positioned at least 2.5 inches below the trailing conveyor 16 and housed within the housing structure 12. The data reader 40 may include a pair of cameras 42, 44 arranged side-by-side to capture the barcode label using a linescan mode. In linescan mode, one or both cameras 42, 44 capture several frames of data through the gap 18 as an item traverses the gap 18 and then combines the data to create a composite image of the entire bottom surface 32 of the item 20, including the barcode. In other embodiments, the data reader 40 may instead be a 1D or 2D imaging reader and include corresponding components different than cameras 42, 44. The data reader 40 captures the barcode label on the bottom surface 32 of the item 20 as the item 20 passes through the gap 18 between the conveyors 14, 16. Each of the cameras 42, 44 provides the data reader 40 with an angled view of approximately 30 degrees, measured from a vertical axis, and scans approximately half of the length of the gap 18. Accordingly, the two views provided by the cameras 42, 44 enable the data reader 40 to capture a barcode label on the item 20 even if the item 20 is irregularly shaped, such as a bag of chips. Because the gap 18 is only approximately four millimeters, and the cameras 42, 44 have an angled view as described, the data reader's 40 scanning length between the gap 18 is approximately two millimeters. In other embodiments, the data reader's 40 scanning length may be larger or smaller based on, for example, the size of the gap 18 and the distance of the data reader 40 in relation to the conveyors 14, 16.

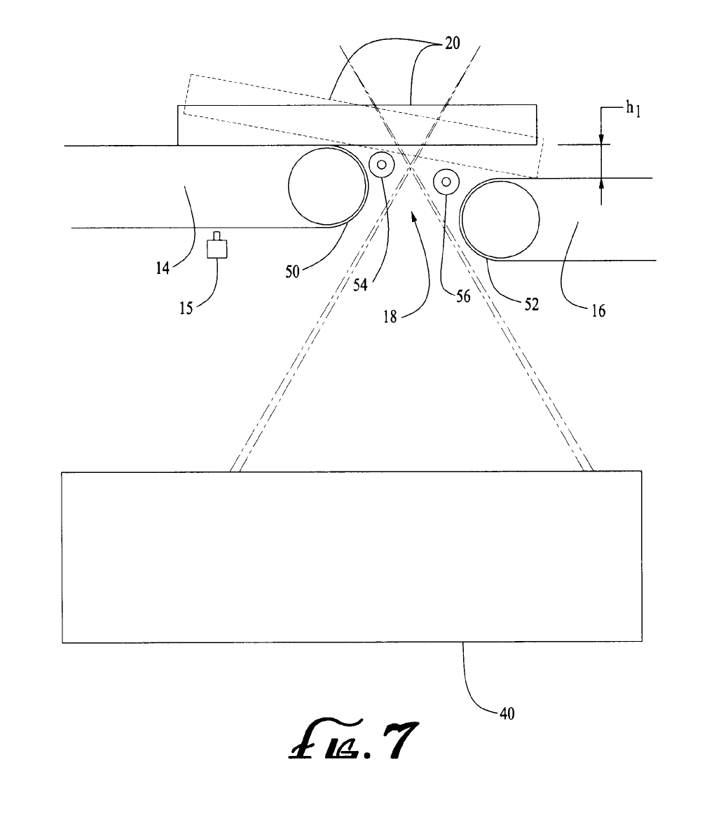

Preferably, the leading conveyor 14 and the trailing conveyor 16 operate at a constant speed, e.g., approximately 304 mm/s, to optimize the performance of the data reader 40. To help monitor and regulate the conveyor speed, the automated checkout system 10 may include a conveyor motion sensor 15 (diagrammatically shown in FIGS. 6 and 7 near the leading conveyor 14, but it may be placed in any suitable location). Additionally, it is preferred that items 20 be placed on the leading conveyor 14 sequentially, in a single file, to avoid the data reader 40 mistakenly reading multiple items as a single item. In other embodiments, optimal performance of the data reader 40 can be achieved with the conveyors 14,16 operating at speeds higher or lower than 304 mm/s without departing from the principles of the embodiment described herein.

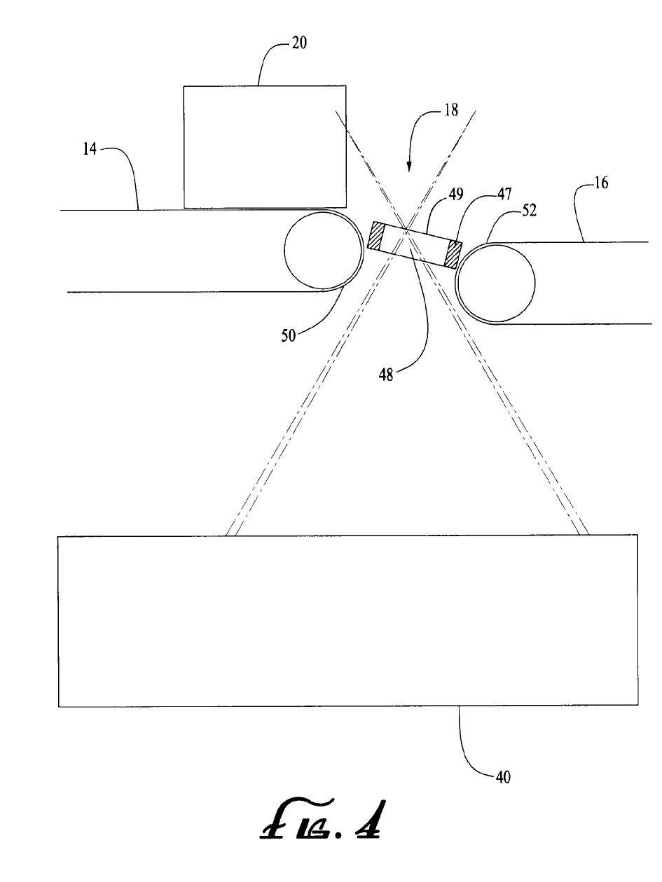

FIG. 4 is a schematic diagram illustrating an alternative embodiment of the automated checkout system 10 with a transfer plate 48 for helping the item 20 transition between the conveyors 14, 16. Depending on the size of the gap 18 and the dimensions of the item 20, transition between the conveyors 14, 16 may be difficult for some items, especially when considering the curvature at the respective edges 50, 52 of the conveyors 14, 16. Some items 20 may become lodged or perhaps fall through the gap 18. As such, the automated checkout system 10 may include a transfer plate 48 positioned in the gap 18 between the leading conveyor 14 and the trailing conveyor 16. It should be understood that although not explicitly described with reference to FIG. 4, the leading conveyor 14, the trailing conveyor 16, the gap 18, and the data reader 40 may have the same or similar characteristics and be arranged in substantially the same or similar relationship as described with reference to the embodiment illustrated in FIGS. 1-3.

In an example operation, the item 20 is transported on the leading conveyor 14 toward the gap 18 and the data reader 40. When the item 20 reaches the gap 18, the item 20 transitions onto the transfer plate 48. As the item 20 slides across the transfer plate 48, the barcode label on the bottom surface 32 is visually exposed to and captured by the data reader 40. Thereafter, the item 20 transitions off the transfer plate 48 and onto the trailing conveyor 16, where the item 20 may then transported to the bagging area 46.

The transfer plate 48 may be entirely comprised of a substantially transparent material 49, such as glass, so that the data reader 40 can scan through the transfer plate 48 and read the barcode label on the bottom surface 32 of the item 20. In an alternative embodiment, an exterior border 47 of the transfer plate 48 may be comprised of metal or other opaque material and only a central portion of the transfer plate 48 may include a substantially transparent window 49 through which the data reader 40 can read the barcode label of the item 20 as it passes along the transfer plate 48. In other embodiments, the substantially transparent window 49 may itself include a slot or gap. For improved accuracy, the clear window or gap should be of sufficient dimension to provide the data reader 40 with a scanning area of at least two millimeters.

In one example construction, the transfer plate 48 is fixedly attached, using suitable techniques, to the housing structure 12 of the automated checkout system 10 and positioned across the gap 18 in a 17-degree downward tilt to provide an optimal scanning area for the data reader 40. The transfer plate 48 has a small clearance on the order of a millimeter off each of the edges 50, 52 so as to avoid interfering with the operation of the conveyors 14, 16. Otherwise, the transfer plate 48 preferably spans the entirety of the gap 18, which may be approximately four millimeters as previously described in an above example.

In another embodiment, the transfer plate 48 may be positioned below the leading conveyor 14 in a substantially horizontal orientation and substantially parallel to the trailing conveyor 16, where the transfer plate 48 extends into the gap 18 and has a small clearance from the edge 52 of trailing conveyor 16 so as to avoid interfering with its operation. In this configuration, the item 20 tilts or drops slightly onto the horizontal transfer plate 48 and thereafter transitions onto the trailing conveyor 16. In some embodiments, the transfer plate 48 may be mounted or otherwise operably connected to a vibration mechanism (not shown) that causes the transfer plate 48 to vibrate. These vibrations, along with the tilt angle of the transfer plate 48, may help the item 20 to move more easily from the leading conveyor 14 to the trailing conveyor 16.

In yet other embodiments, the gap 18 may be larger or smaller than four millimeters and the transfer plate 48 may be positioned at a different angle to accommodate various changes, such as the size of the gap 18 between the conveyors 14, 16 or the vertical distance between the data reader 40 and the conveyors 14, 16.

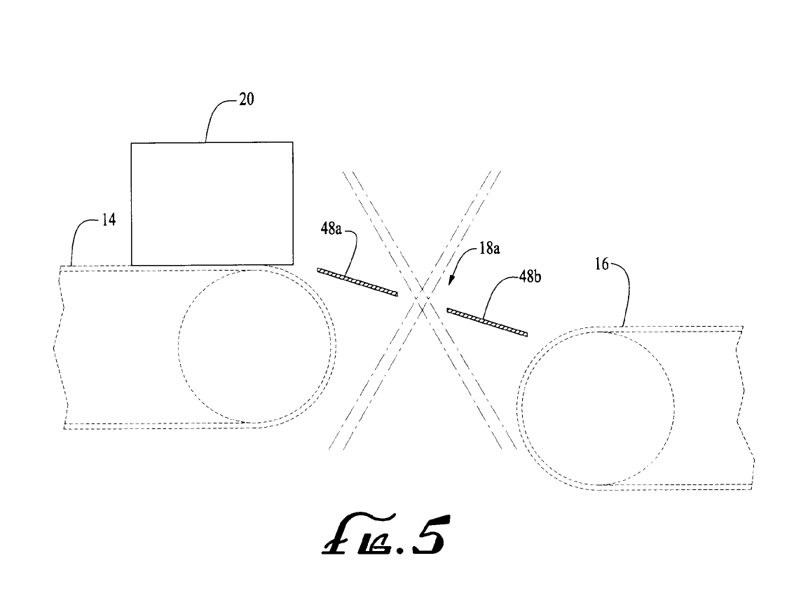

FIG. 5 is a schematic diagram illustrating another embodiment of the automated checkout system 10 including a pair of transfer plates 48a, 48b separated by a small gap 18a through which the data reader 40 can scan the item 20 as it passes between first and second transfer plates 48a, 48b. The automated checkout system 10 operates substantially as described with respect to the embodiment in FIG. 4. Notably, the item 20 will contact the first transfer plate 48a and slide across the space 18a, through which the data reader 40 will capture the barcode label. Thereafter, the item 20 will slide onto the second transfer plate 48b and continue onto the trailing conveyor 16.

FIGS. 6 and 7 are schematic diagrams illustrating another embodiment of the automated checkout system 10 including a plurality of guide rollers 54, 56 for helping the item 20 transition between the conveyors 14, 16 similar to the operation of the transfer plate 48. The automated checkout system 10 includes the data capture device 11 (not shown in this view) the leading conveyor 14 and the trailing conveyor 16 separated by the gap 18, and the data reader 40 substantially in the same relationship as described with reference to FIGS. 1-3. The automated checkout system 10 further includes a leading guide roller 54 and a trailing guide roller 56 positioned in the gap 18 between the leading conveyor 14 and the trailing conveyor 16 for helping the item 20 smoothly transition between the conveyors 14, 16 and helping prevent the item 20 from falling through or becoming lodged in the gap 18.

In an example operation, the item 20 is transported on the leading conveyor 14 toward the gap 18 and the data reader 40. When the item 20 reaches the gap 18, the item 20 transitions onto the leading guide roller 54. As the item 20 slides across the leading guide roller 54 and onto the trailing guide roller 56, the barcode label on the bottom surface 32 is visually exposed to and captured by the data reader 40. Thereafter, the item 20 transitions off the guide rollers 54, 56 and onto the trailing conveyor 16, where the item 20 may then be transported to the bagging area 46. For a larger item 20, the item 20 may span across the two conveyors 14, 16 before tilting downward onto the guide rollers 54, 56 and the trailing conveyor 16 as shown in FIG. 7.

Further details of operation for reading the bottom surface 32 of the item 20 through the gap 18 between conveyors 14, 16 is disclosed in U.S. Patent Application No. 2006/0278708 hereby incorporated by reference.

In a preferred embodiment, the guide rollers 54, 56 are rigidly attached or mounted, using suitable techniques, to the housing structure 12 of the automated checkout system 10 and positioned across the gap 18. For discussion purposes, the gap 18 will be referenced as being four millimeters long. It is understood that simple adjustments to the embodiments described can be made to accommodate different dimensions for the gap 18. The leading guide roller 54 is spaced approximately one millimeter or less from the edge 50 of the leading conveyor 14 and the trailing guide roller 56 is spaced approximately one millimeter or less from the edge 52 of the trailing conveyor 16 so as to avoid interfering with the operation of the conveyors 14, 16. As previously mentioned, the width of the gap 18 is four millimeters, leaving a scanning area of approximately two millimeters between the guide rollers 50, 52 for the data reader 40. The data reader 40, positioned below the conveyors 14, 16 as previously described, is oriented and configured to capture the barcode label on the item 20 between the leading guide roller 54 and the trailing guide roller 56 as the item 20 passes by.

In other embodiments, the guide rollers 54, 56 may be made of a substantially transparent material such that the data reader 40 can accurately read the barcode label on item 20 through the transparent guide rollers 54, 56 in a similar fashion as described with respect to the transparent transfer plate 48 of FIG. 4. In such an embodiment, the scanning area for the data reader 40 would not be limited to the space between the guide rollers 54, 56. Removing this limitation and providing a larger scanning area may improve the accuracy of the data reader 40.

In yet other embodiments, the automated checkout system 10 may include additional guide rollers to accommodate a larger gap 18. For example, if the gap 18 were larger, an extra guide roller or two could be added and spaced out at a proper distance to provide at least a two-millimeter scanning area for the data reader 40 to accurately read the barcode label on the item 20 as it passes along the guide rollers.

In yet another embodiment, an optional transparent transfer plate 57, of similar construction to the plates previously described, may be installed between the guide rollers 54, 56.

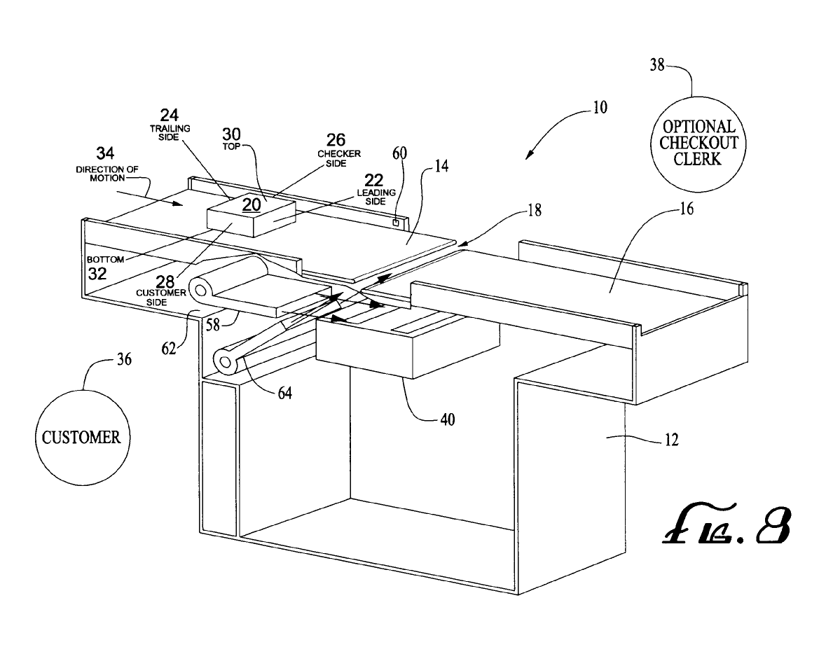

FIG. 8 is a schematic diagram illustrating another embodiment of an automated checkout system 10 including an air blower 58 for helping improve the accuracy and performance of the data reader 40. The automated checkout system 10 includes the leading conveyor 14, the trailing conveyor 16, the gap 18, and the data reader 40 substantially in the same relationship as described with reference to FIGS. 1-3. The automated checkout system 10 further includes an air blower 58 positioned below the conveyors 14, 16 and oriented to direct at least part of the air blower's 58 air flow over the data reader 40 to keep lint, dust, dirt, and other debris from collecting thereon. Performance of the data reader 40 may decline if foreign objects are allowed to collect on the data reader 40. The air blower 58 may be a cooling fan or other cooling unit and thus may also serve to prevent the data reader 40 and any other electronic equipment from overheating. In operation, the item 20 may be processed substantially as described with respect to FIGS. 1-3, but with the additional benefit of the air blower 58 keeping debris off the data reader 40 to help improve its accuracy and performance. The automated checkout system 10 may further include a sensor 60, such as an object sensor or a temperature sensor, for turning the air blower 58 on and off when an item 20 triggers the sensor 60 as the item 20 nears the gap 18. It should be understood that the object sensor 60 may be placed at any suitable location on automated checkout system 10.

In a preferred embodiment, the air blower 58 is positioned and firmly attached on a surface of a necked region 62 of the housing structure 12. In alternative embodiments, the air blower 58 may be positioned elsewhere beneath the conveyors 14, 16 to direct sufficient air flow over the data reader 40.

In yet another embodiment, the air blower 58 can be positioned to direct part of the air flow over the data reader 40 as described above and to also direct part of the air flow through the gap 18 between the conveyors 14, 16 to help prevent debris from falling through the gap 18 onto the data reader 40. Alternatively, this result can be accomplished by using a deflector to direct air flow up through the gap 18 or by providing a second air blower 64 pointed toward the gap 18, while the air blower 58 remains directed at the data reader 40 as previously described. In this configuration, the two air blowers 58, 64 may operate on a time delay in relation to each other so that the respective air flow from the air blowers 58, 64 is properly directed over the data reader 40 and through the gap 18 by the respective air blowers 58, 64. In one arrangement, the object sensor 60 triggers the second air blower 64 to turn on as the item 20 crosses the gap 18. Once the item 20 has crossed, the second air blower 64 turns off and the air blower 58 thereafter turns on to remove any debris that may have fallen onto the data reader 40. In another arrangement, the object sensor 60 may trigger activation of the second air blower 64 as described above, but the air blower 58 may be set to turn on at scheduled intervals to periodically remove any debris that has accumulated on the data reader 40.

Alternatively, the two air blowers 58, 64 could be arranged such that the air flow of the air blower 58 does not cross paths with the air flow of the second air blower 64 so that both air blowers 58, 64 may operate to run concurrently. One configuration could be to have the second air blower 64 positioned above the air blower 58, with the second air blower 64 directed at the gap 18 and the air blower 58 directed at the data reader 40.

In still another embodiment, the air blower 58 may be positioned beneath the conveyors 14, 16 and direct its air flow only toward the gap 18 to prevent debris from falling through onto the data reader 40 while minimal or no air flow is directed at the data reader 40 itself.

In yet other embodiments, the air blowers 58, 64 may be integrated into any of the embodiments described herein to help keep any debris from falling between the gap 18, the transfer plate 48, and/or the guide rollers 54, 56 and prevent the debris from collecting on the data reader 40 and interfering with its performance.

Other embodiments are possible. Although the description above contains much specificity, these details should not be construed as limiting the scope of the invention, but as merely providing illustrations of some embodiments of the invention. It should be understood that subject matter disclosed in one portion herein can be combined with the subject matter of one or more of other portions herein as long as such combinations are not mutually exclusive or inoperable.

The terms and descriptions used above are set forth by way of illustration only and are not meant as limitations. Those skilled in the art will recognize that many variations can be made to the details of the above-described embodiments without departing from the underlying principles of the invention.

1. An automated checkout system for reading encoded data on a bottom surface of an item, the automated checkout system comprising:
a leading conveyor operable to receive and transport an item bearing encoded data;
a trailing conveyor operable to receive and transport the item and spaced apart from the leading conveyor by a gap;
a transition element disposed across the gap and arranged for helping the item transition between the leading conveyor and the trailing conveyor; and
a data reader positioned beneath the leading and trailing conveyors and oriented to read the encoded data on the item through the gap.

2. An automated checkout system according to claim 1, wherein the leading conveyor and trailing conveyor are both aligned along a longitudinal axis such that the item travels along a substantially linear direction of motion.

3. An automated checkout system according to claim 1, wherein the transition element comprises a transfer plate positioned across at least a portion of the gap and arranged for helping the item transition between the leading conveyor and the trailing conveyor.

4. An automated checkout system according to claim 3, wherein the transfer plate comprises a substantially transparent material.

5. An automated checkout stand according to claim 1, wherein the leading conveyor is vertically offset from the trailing conveyor such that the item can be transported across the gap from the leading conveyor onto the trailing conveyor.

6. An automated checkout system according to claim 5, wherein the transition element comprises a transfer plate and the transfer plate is angled downward from the leading conveyor toward the trailing conveyor such that the item slides across the transfer plate as it transitions between the leading and trailing conveyor.

7. An automated checkout system according to claim 6, wherein the substantially transparent material is located on a central region of the transfer plate and dimensioned to provide the data reader with a reading area through the central region.

8. An automated checkout system according to claim 1, wherein the transition element comprises a guide roller positioned across at least a portion of the gap for helping the item transition between the leading conveyor and the trailing conveyor.

9. An automated checkout system according to claim 1, further comprising an air blower positioned beneath the leading and trailing conveyors and oriented to direct air flow toward the data reader to prevent the data reader from collecting debris.

10. An automated checkout system according to claim 9, wherein the air blower is further configured to direct air flow through the gap to help prevent debris from falling through onto the data reader.

11. A method for reading encoded data on a bottom surface of an item, the method comprising:
transporting an item bearing encoded data on a leading conveyor;
transporting the item on the leading conveyor across a gap and onto a trailing conveyor, where a transition element is disposed across at least a portion of the gap; and
reading the encoded data on the item through the gap and the transition element using a data reader positioned beneath the transition element and the leading and trailing conveyors.

12. A method according to claim 11, wherein the leading conveyor is vertically offset in relation to the trailing conveyor.

13. A method according to claim 11, wherein the transition element is a transfer plate or a guide roller.

14. A method according to claim 11, wherein the transition element is substantially transparent and reading using the data reader comprises reading through the transfer mechanism.

15. A method according to claim 11, further comprising positioning an air blower beneath the leading and trailing conveyors to direct air flow over the data reader.
